(19) United States
(12) Patent Application Publication
(10) Pub. No.: US 2008/0148104 A1
(43) Pub. Date: Jun. 19, 2008

(54) Detecting an Agent Generating a Parity Error on a PCI-Compatible Bus

(76) Inventors: Michael G. Brinkman, Raleigh, NC (US); Timothy J. Schlude, Cary, NC (US); Gregory D. Sellman, Morrisville, NC (US)

Correspondence Address: IBM (RPS-BLF);c/o BIGGERS & OHANIAN, LLP, P.O. BOX 1469, AUSTIN, TX, 78767-1469, US

(21) Appl. No.: 11/469,635

(22) Filed: Sep. 1, 2006

(51) Int. Cl. G06F 11/00

(52) U.S. Cl. 714/43

(57) ABSTRACT

Methods, apparatus, and products are disclosed for detecting an agent generating a parity error on a PCI-compatible bus that include detecting, by an administrative agent on the bus, a parity error that occurred during a transaction on a PCI-compatible bus that connects a plurality of agents for data communications, retrieving, by the administrative agent, a value for a grant signal associated with each agent on the bus for the transaction, retrieving, by the administrative agent, values for an address signal and a command signal for the transaction, and identifying, by the administrative agent, the agent generating the parity error in dependence upon the values for the grant signals, the address signal, and the command signal.

### BACKGROUND OF THE INVENTION

1. Field of the Invention

The field of the invention is data processing, or, more specifically, methods, apparatus, and products for detecting an agent generating a parity error on a PCI-compatible bus.

2. Description of Related Art

In the current art, many computer systems employ Peripheral Component Interconnect (‘PCI’) or PCI-eXtended (‘PCI-X’) buses to transfer data between agents connected to the bus. An agent is any device, such as, for example, a bus controller or bus adapter, connected to the bus. On computer systems that employ PCI or PCI-X buses with multiple agents, an agent that sends data to another agent on the bus often generates a parity error when the data is transferred on the bus. Currently, however, no mechanism exists to identify the agent generating a parity error during a transfer on the bus. The current inability to identify the agent generating the parity error exists because the parity error is detected by the agent that receives the data during the transfer on the bus and no record of the agent that sent the data during a transaction is maintained.

### SUMMARY OF THE INVENTION

Methods, apparatus, and products are disclosed for detecting an agent generating a parity error on a PCI-compatible bus that include detecting, by an administrative agent on the bus, a parity error that occurred during a transaction on a PCI-compatible bus that connects a plurality of agents for data communications, retrieving, by the administrative agent, a value for a grant signal associated with each agent on the bus for the transaction, retrieving, by the administrative agent, values for an address signal and a command signal for the transaction, and identifying, by the administrative agent, the agent generating the parity error in dependence upon the values for the grant signals, the address signal, and the command signal.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an example of a computer useful in detecting an agent generating a parity error on a PCI-compatible bus according to embodiments of the present invention.

FIG. 2 sets forth a flow chart illustrating an exemplary method for detecting an agent generating a parity error on a PCI-compatible bus according to embodiments of the present invention.

FIG. 3 sets forth a flow chart illustrating a further exemplary method for detecting an agent generating a parity error on a PCI-compatible bus according to embodiments of the present invention.

FIG. 4 sets forth a flow chart illustrating a further exemplary method for detecting an agent generating a parity error on a PCI-compatible bus according to embodiments of the present invention.

### DETAILED DESCRIPTION OF EXEMPLARY EMBODIMENTS

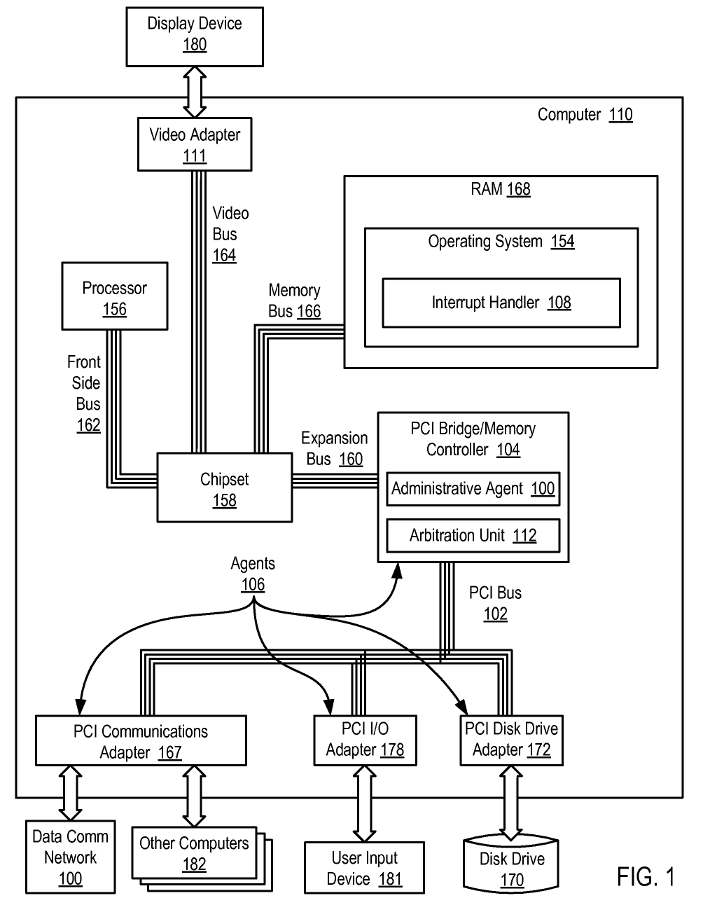

Exemplary methods, apparatus, and products for detecting an agent generating a parity error on a PCI-compatible bus according to embodiments of the present invention are described with reference to the accompanying drawings, beginning with FIG. 1. FIG. 1 sets forth a block diagram of automated computing machinery comprising an exemplary computer (110) useful in detecting an agent generating a parity error on a PCI-compatible bus according to embodiments of the present invention. A PCI-compatible bus is a computer bus implemented according to the PCI family of specifications or a specification such as, for example, the PCI-X specification that is compatible with the PCI specification. The PCI-X specification is said to be ‘compatible’ with the PCI specification in that the PCI-X specification is an extension of the PCI specification. That is, for example, a PCI-X card may be installed in a standard PCI slot and that PCI and PCI-X cards may be intermixed on a PCI-X bus. In this specification, the terms ‘PCI’ and ‘PCI-compatible’ are used interchangeably.

The exemplary computer (110) of FIG. 1 includes several agents (106) connected to a PCI bus (102) for data communications. An agent (106) is a device implemented according to the PCI and PCI-compatible family of specifications promulgated by the PCI Special Interest Group (‘PCI-SIG®’). An agent (106) may be implemented as a PCI bridge, PCI memory controller, a PCI adapter, and any other PCI device connected to a PCI bus as will occur to those of skill in the art. In the example of FIG. 1, the agents (106) are implemented as a PCI bridge/memory controller (104), a PCI communications adapter (167), a PCI input/output adapter (178), and a PCI disk drive adapter (172).

The PCI bridge/memory controller (104) of FIG. 1 is a PCI device that serves as an interface between the agents (106) connected to the PCI bus (102) and the other components of the exemplary computer (110). The PCI bridge/memory controller (104) of FIG. 1 connects to the other components of the exemplary computer (110) through the expansion bus (160) and a chipset (158). An example of a PCI bridge/memory controller improved for detecting an agent generating a parity error on a PCI-compatible bus according to embodiments of the present invention may include the Atmel® PC107 PCI Bridge/Integrated Memory Controller and the Freescale™ Semiconductor MPC105 PCI Bridge/Memory Controller.

In the exemplary system of FIG. 1, the PCI bridge/memory controller (104) includes an arbitration unit (112). The arbitration unit (112) is computer hardware that determines which agent (106) has access to the PCI bus (102) for a particular transaction on the bus. Agents (106) arbitrate to initiate a transaction on the bus by asserting a request signal (‘REQ#’) to the arbitration unit (112). The arbitration unit (112) grants ownership of the bus by asserting a grant signal (‘GNT#’). A request signal line and a grant signal line exist for each agent installed in the computer (110) and allow the arbitration unit (112) to implement a bus fairness algorithm out of band with the transactions that occur on the bus (102). The arbitration process to determine the next agent allowed to initiate a transaction on the bus, therefore, typically overlaps the current transaction on the bus (102).

A transaction is a unit of interaction between two agents (106) on the PCI bus (102) and typically includes the exchange of an address signal and one or more subsequent data signals on the PCI bus (102). The agent initiating the transaction is referred to as the ‘master agent,’ and the agent responding to the master agent is referred to as the ‘target agent.’ To implement a transaction, the PCI bus (102) includes multiplexed address signal and data signal (‘AD’) lines that typically support 32-bit and 64-bit data transfers. The first phase of a transaction is referred to as the ‘address phase.’ The address phase begins when the master agent asserts the frame signal (‘FRAME#’) on the frame signal line during the first clock edge after the previous transaction. When the master agent asserts the FRAME#, the master agent drives an address signal onto the AD lines. The next clock edge after the start of the address phase begins the first of one or more ‘data phases’ in which data is transferred over the AD lines.

During the address phase, the master agent drives the command signal (‘C/BE#’) on to the command signal lines to signal the type of transaction on the bus. Transaction types may include, for example, memory read, memory write, I/O read, I/O write, and so on. During data phases of a transaction, the command signals serve as byte enable indicator that represent which data bytes are valid on the AD lines. Both the master agent and the target agent may insert wait states into the data transfer by deasserting either the initiator ready signal (‘IRDY#’) or the target ready signal (‘TRDY#’). Valid data transfers occur on each clock edge in which both the initiator ready signal and the target ready signal are asserted.

As mentioned above, a transaction on the PCI bus (102) consists of one address phase and any number of subsequent data phases. Input/Output transactions that access registers within a target agent typically have only a single data phase. Memory transactions that move blocks of data typically consist of multiple data phases that read or write to multiple consecutive memory locations. Both the master agent and the target agent may terminate a transaction at any time. The master agent signals the completion of the transaction by deasserting the FRAME# signal during the last data phase. A target agent may terminate a bus transfer by asserting a stop signal (‘STOP#’). When the master agent detects that the STOP# is asserted, the master agent must terminate the current transaction and re-arbitrate for the PCI bus (102) before continuing. If the STOP# is asserted without any data phases completing, the target agent has issued a ‘retry.’ If the STOP# is asserted after one or more data phases have successfully completed, the target has issued a ‘disconnect.’

When an agent receives data during the address phase or data phase of a transaction, the agent detects parity errors on the received data using a parity bit. A parity bit is a binary digit that stores the parity of a set of bits transferred on the bus. The parity of a set of bits indicates whether the number of bits with value of one in the given set of bits is even or odd. A parity error is detected when the agent calculates the parity for a received set of bits and the calculated parity does not match the value contained in the received parity bit. If the agent detects a parity error in the data received during the address phase of the transaction, then the agent asserts a system error signal (‘SERR#’). If the agent detects a parity error in the data received during one of the data phases of the transaction, then the agent asserts a parity error signal (‘PERR#’).

In the exemplary system of FIG. 1, the PCI bridge/memory controller (104) includes an administrative agent (100). The administrative agent (100) is a computer device for detecting an agent generating a parity error on a PCI-compatible bus according to embodiment of the present invention. The administrative agent (100) operates generally for detecting an agent generating a parity error on a PCI-compatible bus according to embodiment of the present invention by detecting a parity error that occurred during a transaction on a PCI-compatible bus that connects a plurality of agents for data communications, retrieving a value for a grant signal associated with each agent on the bus for the transaction, retrieving values for an address signal and a command signal for the transaction, and identifying the agent generating the parity error in dependence upon the values for the grant signals, the address signal, and the command signal. The administrative agent (100) of FIG. 1 may be implemented using logic gates in an application-specific integrated circuit (‘ASIC’) or any other implementation as will occur to those of skill in the art.

Readers will note that FIG. 1 depicts the administrative agent (100) installed in the PCI bridge/memory controller (104). Such a depiction is for explanation and not for limitation. In fact, the administrative agent (100) may exist as a standalone device directly connected to the PCI bus (102) to monitor bus signals in detecting an agent generating a parity error on a PCI-compatible bus according to embodiment of the present invention.

For further explanation, Table 1 below identifies six exemplary transaction scenarios in which the administrative agent (100) of FIG. 1 may operate to detect an agent (106) generating a parity error on a PCI-compatible bus according to embodiment of the present invention. The six transaction scenarios include: a read by a memory controller from an adapter, a write by the memory controller to an adapter, a read by an adapter from the memory controller, a write by an adapter to the memory controller, a read from one adapter to another adapter, and a write from one adapter to another adapter. Table 1 below describes each of these transaction scenarios by transaction type, the master agent of the transaction, the target agent of the transaction, which agent signaled the parity error, and the signal required for identification of the agent generating the parity error.

| | Transaction | Master | Target | Parity Error | Req. Sigs. |
|---|---|---|---|---|---|
| | Type | Agent | Agent | Signaled By | For Id. |
| 1 | Read | Mem. Cntrl. | Adapter A | Mem. Cntrl. | AD |
| 2 | Write | Mem. Cntrl. | Adapter A | Adapter A | GNT# |
| 3 | Read | Adapter A | Mem. Cntrl. | Adapter A | AD |
| 4 | Write | Adapter A | Mem. Cntrl. | Mem. Cntrl. | GNT# |
| 5 | Read | Adapter A | Adapter B | Adapter A | AD |
| 6 | Write | Adapter A | Adapter B | Adapter B | GNT# |

Readers will note from the exemplary table above that the signal required for identification of the agent generating the parity error corresponds with whether the transaction type is a read transaction or a write transaction. During a write transaction, the signal required for identification of the agent generating the parity error is the grant signal (‘GNT#’). A write transaction is a transaction in which the master agent is writing data to a target agent on the bus. During a write transaction, the master agent generates the parity error because the master agent is the agent that provides the data. As explained above, the master agent is the agent on the bus (102) to which the arbitration unit (112) asserts a grant signal. The administration agent (100) of FIG. 1, therefore, may identify the agent generating the parity error during a write transaction by observing to which agent (106) the arbitration unit (112) asserted a grant signal.

From the exemplary table above, readers will note that the signal required for identification of the agent generating the parity error is the address signal (‘AD’) during a read transaction. A read transaction is a transaction in which the master agent is reading data from a target agent on the bus. During a read transaction, the target agent generates the parity error because the data is read from a memory or I/O address in the address space of target agent. The administration agent (100) of FIG. 1, therefore, may identify the agent generating the parity error during a read transaction by observing the address transmitted during the address phase of the read transaction and identifying the agent whose address space contains the value of the address for the transaction.

Turning back to FIG. 1, the computer (110) includes at least one computer processor (156) or ‘CPU’ as well as random access memory (168) (‘RAM’) which is connected through a high speed memory bus (166) and a chipset (158) to processor (156) and to other components of the computer. Stored in RAM (168) is an operating system (154). Operating systems useful in computers according to embodiments of the present invention include UNIX™, Linux™, Microsoft NT™, IBM's AIX™, IBM's i5/OS™, and others as will occur to those of skill in the art. The operating system (154) in the example of FIG. 1 is shown in RAM (168), but many components of such software typically are stored in non-volatile memory also, for example, on a disk drive (170).

In the example of FIG. 1, the operating system (154) includes an interrupt handler (108). The interrupt handler (108) of FIG. 1 is a subroutine in an operating system whose execution is triggered by the processor's reception of an interrupt. Such an interrupt may be generated by the PCI Bridge/Memory Controller (104) when the PCI Bridge/Memory Controller (104) detects a parity error that occurred during a transaction on the PCI bus (102) using PERR# or SERR#. When the processor receives an interrupt, the processor executes the interrupt handler (108) to query all the status registers of all the agents (106) on the bus, including an error register of the administrative agent (100). In the example of FIG. 1, the interrupt handler (108) includes computer program instructions for detecting an agent generating a parity error on a PCI-compatible bus according to embodiments of the present invention. The interrupt handler (108) of FIG. 1 operates generally for detecting an agent generating a parity error on a PCI-compatible bus according to embodiments of the present invention by retrieving, from the administrative agent (100), an identity of the agent generating the parity error on the bus, and administering the identity of the agent generating the parity error. Although FIG. 1 depicts the interrupt handler (108) as a component of the operating system (154), such a depiction is for explanation and not for limitation. In fact, interrupt handler (108) may be a component of a device driver distinct from the operating system (154) that is used to administer the administrative agent (100).

The exemplary computer (110) of FIG. 1 also includes a chipset (158), computer hardware components that contain drive electronics for high speed buses, the front side bus (162), the video bus (164), and the memory bus (166), as well as drive electronics for the slower expansion bus (160). Examples of chipsets useful in computers useful according to embodiments of the present invention include the Intel Northbridge, the Intel Memory Controller Hub, the Intel Southbridge, and the Intel I/O Controller Hub. Examples of expansion buses useful in computers useful according to embodiments of the present invention may include Peripheral Component Interconnect (‘PCI’) buses and PCI Express (‘PCIe’) buses. Readers will note that FIG. 1 depicts the chipset (158) distinct from the PCI Bridge/Memory Controller (104). Such a depiction is for explanation and not for limitation. In fact, the chipset (158) and the PCI Bridge/Memory Controller (104) may be merged into a single component is some embodiments of the present invention.

The exemplary computer (110) of FIG. 1 also includes PCI disk drive adapter (172) coupled through the PCI bus (102), the PCI Bridge/Memory Controller (104), expansion bus (160), and the chipset (158) to processor (156) and other components of the exemplary computer (110). Disk drive adapter (172) connects non-volatile data storage to the exemplary computer (110) in the form of disk drive (170). Other non-volatile data storage may be implemented for a computer as an optical disk drive, electrically erasable programmable read-only memory (so-called ‘EEPROM’ or ‘Flash’ memory), RAM drives, and so on, as will occur to those of skill in the art.

The exemplary computer (110) of FIG. 1 includes one or more PCI input/output (‘I/O’) adapters (178). PCI I/O adapters in computers implement user-oriented input/output through, for example, software drivers and computer hardware for controlling output to display devices such as computer display screens, as well as user input from user input devices (181) such as keyboards and mice. The exemplary computer (110) of FIG. 1 includes a video adapter (111), which is an example of an I/O adapter specially designed for graphic output to a display device (180) such as a display screen or computer monitor. Video adapter (111) is connected to processor (156) through a high speed video bus (164), chipset (158), and the front side bus (162), which is also a high speed bus.

The exemplary computer (110) of FIG. 1 includes a PCI communications adapter (167) for data communications with other computers (182) and for data communications with data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for detecting an agent generating a parity error on a PCI-compatible bus according to embodiments of the present invention include modems for wired dial-up communications, IEEE 802.3 Ethernet adapters for wired data communications network communications, and IEEE 802.11b adapters for wireless data communications network communications.

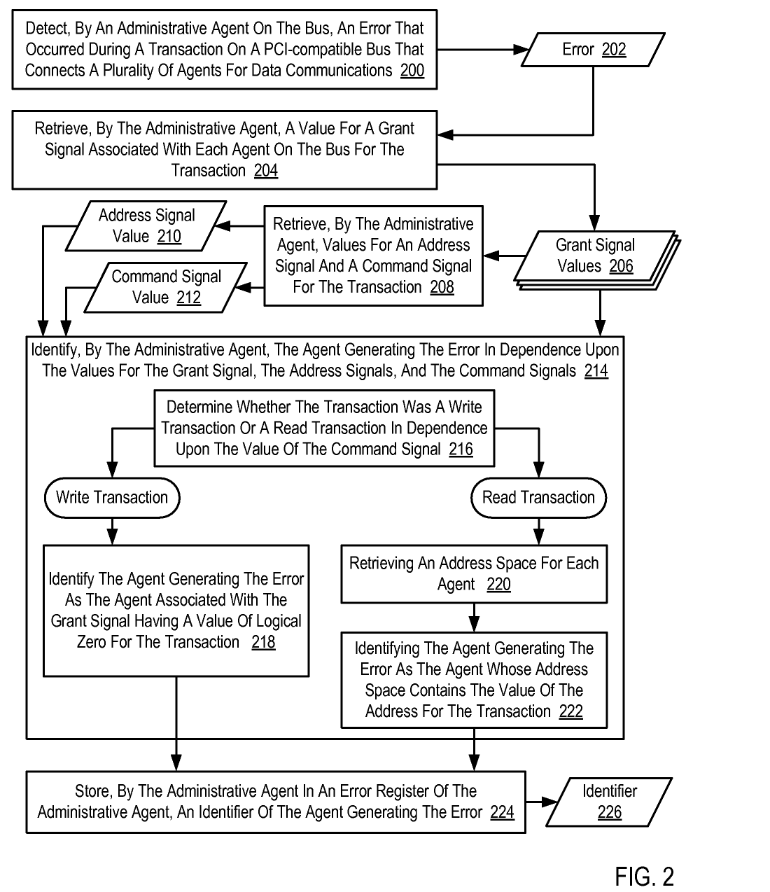

For further explanation, FIG. 2 sets forth a flow chart illustrating an exemplary method for detecting an agent generating a parity error on a PCI-compatible bus according to embodiments of the present invention. The method of FIG. 2 includes detecting (200), by an administrative agent on the bus, a parity error (202) that occurred during a transaction on a PCI-compatible bus that connects a plurality of agents for data communications. The parity error (202) of the FIG. 2 represents an error detected by the administrative agent when an agent on the bus calculated the parity for a received set of bits and the calculated parity did not match the value contained in the received parity bit. Detecting (200), by an administrative agent on the bus, a parity error (202) that occurred during a transaction on a PCI-compatible bus that connects a plurality of agents for data communications according to the method of FIG. 2 may be carried out by detecting that an agent on the bus asserted either SERR# or PERR#. An agent on the bus may assert SERR# when the agent detects a parity error for the data transferred during the address phase of the transaction on the bus. An agent on the bus may assert PERR# when the agent detects a parity error for the data transferred during the one or more data phases of the transaction on the bus.

The method of FIG. 2 also includes retrieving (204), by the administrative agent, a value (206) for a grant signal (‘GNT#’) associated with each agent on the bus for the transaction. The grant signal values (206) of FIG. 2 represent logical values for the grant signal associated with each agent on the bus for a particular transaction. The grant signal value (206) of FIG. 2 for the grant signal associated with the master agent for a particular transaction will be logical zero, while the grant signal values (206) for the grant signal associated with all other agents on the bus will be logical one. In the method of FIG. 2, retrieving (204), by the administrative agent, a value (206) for a grant signal associated with each agent on the bus for the transaction may be carried out by sampling the voltage level of the grant signal line for each agent and identifying the grant signal value (206) for each grant signal line as either logical one or logical zero independence upon the sampled voltage level. Readers will note that because the arbitration process discussed above begins before the address phase of a transaction, the administrative agent may sample the voltage level of the grant signal line for each agent before the address phase of the transaction on the bus.

The method of FIG. 2 also includes retrieving (208), by the administrative agent, values (210, 212) for an address signal (‘AD’) and a command signal (‘C/BE#’) for the transaction. The address signal value (210) of FIG. 2 represents the aggregation of signal values on each address signal line of the PCI bus. Typical implementations of the PCI bus have thirty-two address/data signal lines—although the PCI specification provides for up to sixty-four address/data signal lines. The command signal value (212) of FIG. 2 represents the aggregation of signal values on each of the four command signal line of the PCI bus. In the method of FIG. 2, retrieving (208), by the administrative agent, values (210, 212) for an address signal and a command signal for the transaction may be carried out by sampling the voltage level of each address signal line and each command signal line included in the bus during the address phase of the transaction.

The method of FIG. 2 also includes identifying (214), by the administrative agent, the agent generating the parity error in dependence upon the values (206, 210, 212) for the grant signals, the address signal, and the command signal. Identifying (214), by the administrative agent, the agent generating the parity error in dependence upon the values (206, 210, 212) for the grant signals, the address signal, and the command signal according to the method of FIG. 2 includes determining (216) whether the transaction was a write transaction or a read transaction in dependence upon the value of the command signal. According to the PCI family of specifications the transaction is a write transaction if the command signal value (212) is either ‘0011’ or ‘0111.’ The transaction is a read transaction, however, if the command signal value (212) is either ‘0010’ or ‘0110.’

In the method of FIG. 2, identifying (214) the agent generating the parity error also includes identifying (218) the agent generating the parity error as the agent associated with the grant signal having a value of logical zero for the transaction if the transaction was a write transaction. As mentioned above, a request signal line and a grant signal line exists between each agent on the bus and a bus arbitration unit. The bus arbitration unit asserts the grant signal to an agent that will serve as the master agent for the next transaction on the bus. The bus arbitration unit asserts the grant signal for an agent on the bus by lowering the voltage on the grant signal line to a level that represents a logical zero. During a write transaction, therefore, the agent generating the parity error is the agent associated with the grant signal having a value of logical zero.

In the method of FIG. 2, identifying (214) the agent generating the parity error also includes retrieving (220) an address space for each agent if the transaction was a read transaction and identifying (222) the agent generating the parity error as the agent whose address space contains the value (210) of the address signal for the transaction when the transaction was a read transaction. Retrieving (220) an address space for each agent according to the method of FIG. 2 may be carried out by accessing the base address registers in the PCI configuration header of each agent on the bus. The base address registers are registers that are used to determine and allocate the type, amount and location of PCI I/O address space and PCI memory address space that each agent may use. Identifying (222) the agent generating the parity error as the agent whose address space contains the value (210) of the address signal for the transaction according to the method of FIG. 2 may be carried out by comparing the address signal value (210) to the address space for each agent on the bus until an address space for an agent is found to contain the address signal value (210).

The method of FIG. 2 also includes storing (224), by the administrative agent in an error register of the administrative agent, an identifier (226) of the agent generating the parity error. In FIG. 2, the identifier (226) of the agent generating the parity error may be implemented as a combination of the bus number and device number for the agent generating the parity error. The bus number and device number are assigned to an agent according to the agent's location in the PCI bus topology. The identifier (226) of the agent generating the parity error in the example of FIG. 2 may also be implemented as a combination of the vendor identifier, device identifier, and index number of the agent on the bus. The vendor identifier is a unique number describing the vendor of the agent. For example, Digital's PCI vendor identification is ‘0x1011’ and Intel's PCI vendor identification is ‘0x8086.’ The device identifier is a unique number describing the agent itself. For example, a Digital 21141 fast Ethernet device has a PCI device identification of ‘0x0009.’ The bus number, device number, vendor identifier, device identifier, and index of an agent connected to the bus may be obtained using standard BIOS functions described in the PCI BIOS Specification promulgated by the PCI-SIG® such as, for example, FIND_PCI_DEVICE. Although implementations of the identifier (226) of the agent generating the parity error in the example of FIG. 2 are described in terms of bus number, device number, vendor identifier, device identifier, and index of an agent connected to the bus, other implementation of the identifier (226) as will occur to those of skill in the art may be useful in detecting an agent generating a parity error on a PCI-compatible bus according to embodiments of the present invention.

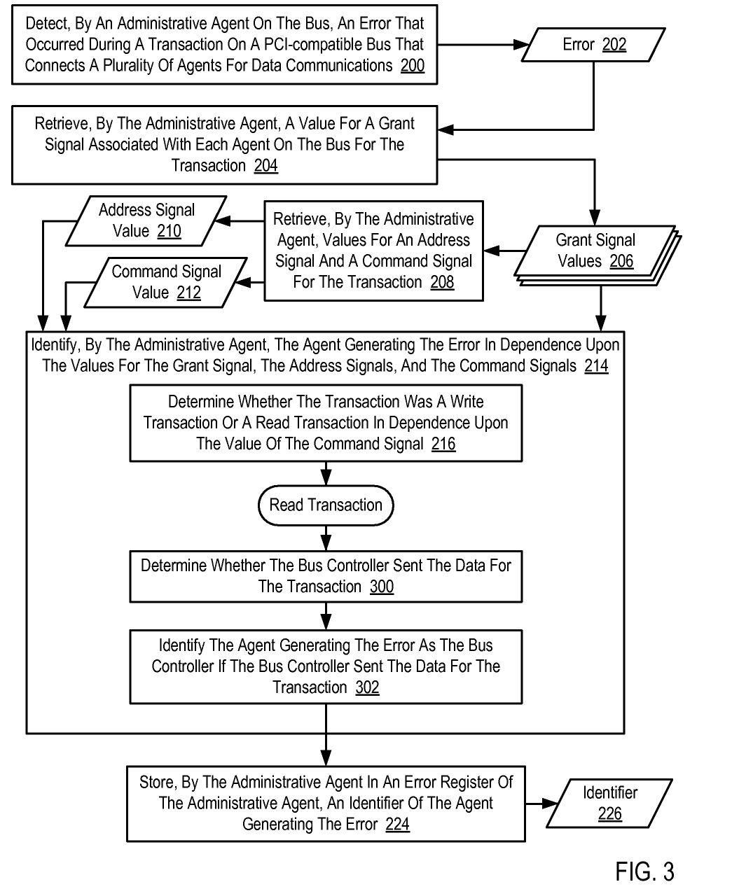

Readers will note from above that the administrative agent may be installed in a bus controller such as, for example, the PCI bridge/memory controller depicted in FIG. 1. When the administrative agent is installed in a bus controller, identifying the agent generating the parity error in dependence upon the values for the grant signals, the address signal, and the command signal may be carried out by identifying the agent generating the parity error as the bus controller if the bus controller sent the data for the read transaction. For further explanation, FIG. 3 sets forth a flow chart illustrating a further exemplary method for detecting an agent generating a parity error on a PCI-compatible bus according to embodiments of the present invention in which the administrative agent is installed in a bus controller for the bus.

The method of FIG. 3 is similar to the method of FIG. 2. The method of FIG. 3 is similar to the method of FIG. 2 in that the method of FIG. 3 includes detecting (200), by an administrative agent on the bus, a parity error (202) that occurred during a transaction on a PCI-compatible bus that connects a plurality of agents for data communications, retrieving (204), by the administrative agent, a value (206) for a grant signal associated with each agent on the bus for the transaction, retrieving (208), by the administrative agent, values (210, 212) for an address signal and a command signal for the transaction, identifying (214), by the administrative agent, the agent generating the parity error in dependence upon the values (206, 210, 212) for the grant signals, the address signal, and the command signal, determining (216) whether the transaction was a write transaction or a read transaction in dependence upon the value of the command signal, and storing (224), by the administrative agent in an error register of the administrative agent, an identifier (226) of the agent generating the parity error. The example of FIG. 3 is also similar to the example of FIG. 2 in that the example of FIG. 3 includes parity error (202), grant signal values (206), an address signal value (210), a command signal value (212), and an identifier (226) of the agent generating the parity error.

The method of FIG. 3 differs from the method of FIG. 2 in manner in which identifying (214), by the administrative agent, the agent generating the parity error in dependence upon the values (206, 210, 212) for the grant signals, the address signal, and the command signal according to the method of FIG. 3 is carried out. Because the administrative agent is installed in a bus controller in the method of FIG. 3, the administrative agent does not identify (214) the agent generating the parity error by retrieving the address space for the bus controller and identifying the agent generating the parity error as the bus controller if the bus controller's address space contains the address signal value (210) for the transaction as discussed above with reference to FIG. 2. Rather, identifying (214), by the administrative agent, the agent generating the parity error in dependence upon the values (206, 210, 212) for the grant signals, the address signal, and the command signal according to the method of FIG. 3 includes determining (300) whether the bus controller sent the data for the transaction if the transaction was a read transaction, and identifying (302) the agent generating the parity error as the bus controller if the bus controller sent the data for the transaction and if the transaction was a read transaction. Determining (300) whether the bus controller sent the data for the transaction if the transaction was a read transaction according to the method of FIG. 3 may be carried out by monitoring whether the bus controller was the data sender when either the SERR# or PERR# is asserted.

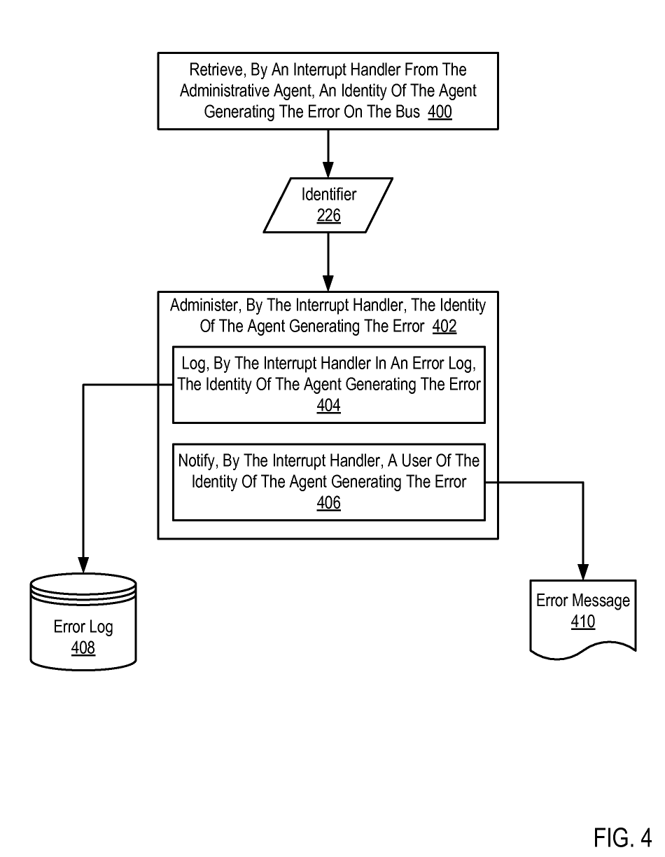

When the administrative agent identifies the agent on the PCI bus generating the parity error, an interrupt handler may provide the identity of the agent generating the to a system administrator so that the system administrator may service the error generating agent. Before the interrupt handler makes the identity of the agent generating the parity error available to the system administrator, however, the interrupt handler must retrieve identity of the agent generating the parity error from the administrative agent. For further explanation, FIG. 4 sets forth a flow chart illustrating a further exemplary method for detecting an agent generating a parity error on a PCI-compatible bus according to embodiments of the present invention that includes retrieving (400), by an interrupt handler from the administrative agent, an identity of the agent generating the parity error on the bus. Retrieving (400), by an interrupt handler from the administrative agent, an identity of the agent generating the parity error on the bus according to the method of FIG. 4 may be carried out by retrieving an identifier (226) of the agent generating the parity error from an error register of the administrative agent using standard BIOS functions described in BIOS specifications such as, for example, the BIOS Boot Specification developed by the Compaq Computer Corporation, Phoenix Technologies Ltd., and the Intel Corporation, and the PCI BIOS Specification promulgated by the PCI SIG®. In the example of FIG. 4, the identifier (226) of the agent generating the parity error is the same identifier (226) of the agent generating the parity error as discussed above with reference to FIG. 3.

The method of FIG. 4 also includes administering (402), by the interrupt handler, the identity of the agent generating the parity error. Administering (402), by the interrupt handler, the identity of the agent generating the parity error according to the method of FIG. 4 includes logging (404), by the interrupt handler in an error log, the identity of the agent generating the parity error. In the method of FIG. 4, logging (404), by the interrupt handler in an error log, the identity of the agent generating the parity error may be carried out by storing the identifier (226) of the agent generating the parity error in an error log (408) accessible by a system administrator. The error log (408) represents data storage such as, for example, a database, a file system, or any other data storage as will occur to those of skill in the art.

In the method of FIG. 4, administering (402), by the interrupt handler, the identity of the agent generating the parity error also includes notifying (406), by the interrupt handler, a user of the identity of the agent generating the parity error. Notifying (406), by the interrupt handler, a user of the identity of the agent generating the parity error according to the method of FIG. 4 may be carried out by sending an error message (410) that includes the identifier (226) of the agent generating the parity error to a system administrator. The error message (410) may be implemented as an email message sent to an email server, a chat message sent to a chat server, a system administration message conveyed to a system administrator directly by the interrupt handler itself using a graphical user interface (‘GUI’), or any other message as will occur to those of skill in the art.

Exemplary embodiments of the present invention are described largely in the context of a fully functional computer system for detecting an agent generating a parity error on a PCI-compatible bus. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for detecting an agent generating a parity error on a PCI-compatible bus, the method comprising:
detecting, by an administrative agent on the bus, a parity error that occurred during a transaction on a PCI-compatible bus that connects a plurality of agents for data communications;
retrieving, by the administrative agent, a value for a grant signal associated with each agent on the bus for the transaction;
retrieving, by the administrative agent, values for an address signal and a command signal for the transaction; and
identifying, by the administrative agent, the agent generating the parity error in dependence upon the values for the grant signals, the address signal, and the command signal.

2. The method of claim 1 wherein identifying, by the administrative agent, the agent generating the parity error in dependence upon the values for the grant signals, the address signal, and the command signal further comprises:
determining whether the transaction was a write transaction or a read transaction in dependence upon the value of the command signal; and
identifying the agent generating the parity error as the agent associated with the grant signal having a value of logical zero for the transaction if the transaction was a write transaction.

3. The method of claim 1 wherein identifying, by the administrative agent, the agent generating the parity error in dependence upon the values for the grant signals, the address signal, and the command signal further comprises:
determining whether the transaction was a write transaction or a read transaction in dependence upon the value of the command signal; and
if the transaction was a read transaction,
retrieving an address space for each agent, and
identifying the agent generating the parity error as the agent whose address space contains the value of the address signal for the transaction.

4. The method of claim 1 wherein the administrative agent is installed in a bus controller for the bus and wherein identifying, by the administrative agent, the agent generating the parity error in dependence upon the values for the grant signals, the address signal, and the command signal further comprises:
determining whether the transaction was a write transaction or a read transaction in dependence upon the value of the command signal; and
if the transaction was a read transaction,
determining whether the bus controller sent the data for the transaction, and
identifying the agent generating the parity error as the bus controller if the bus controller sent the data for the transaction.

5. The method of claim 1 further comprising:
storing, by the administrative agent in an error register of the administrative agent, an identifier of the agent generating the parity error.

6. The method of claim 1 further comprising:
retrieving, by an interrupt handler from the administrative agent, an identity of the agent generating the parity error on the bus; and
administering, by the interrupt handler, the identity of the agent generating the parity error.

7. The method of claim 6 wherein administering, by the interrupt handler, the identity of the agent generating the parity error further comprises:
logging, by the interrupt handler in an error log, the identity of the agent generating the parity error.

8. The method of claim 6 wherein administering, by the interrupt handler, the identity of the agent generating the parity error further comprises:
notifying, by the interrupt handler, a user of the identity of the agent generating the parity error.

9. An administrative agent on a PCI-compatible bus for detecting an agent generating a parity error on the bus, the administrative agent comprising:
means for detecting a parity error that occurred during a transaction on a PCI-compatible bus that connects a plurality of agents for data communications;
means for retrieving a value for a grant signal associated with each agent on the bus for the transaction;
means for retrieving values for an address signal and a command signal for the transaction; and
means for identifying the agent generating the parity error in dependence upon the values for the grant signals, the address signal, and the command signal.

10. The administrative agent of claim 9 wherein the means for identifying the agent generating the parity error in dependence upon the values for the grant signals, the address signal, and the command signal further comprises:
means for determining whether the transaction was a write transaction or a read transaction in dependence upon the value of the command signal; and
means for identifying the agent generating the parity error as the agent associated with the grant signal having a value of logical zero for the transaction if the transaction was a write transaction.

11. The administrative agent of claim 9 wherein the means for identifying the agent generating the parity error in dependence upon the values for the grant signals, the address signal, and the command signal further comprises:
means for determining whether the transaction was a write transaction or a read transaction in dependence upon the value of the command signal; and
if the transaction was a read transaction,
means for retrieving an address space for each agent, and
means for identifying the agent generating the parity error as the agent whose address space contains the value of the address signal for the transaction.

12. The administrative agent of claim 9 wherein the administrative agent is installed in a bus controller for the bus and wherein the means for identifying the agent generating the parity error in dependence upon the values for the grant signals, the address signal, and the command signal further comprises:
means for determining whether the transaction was a write transaction or a read transaction in dependence upon the value of the command signal; and
if the transaction was a read transaction,
means for determining whether the bus controller sent the data for the transaction, and
means for identifying the agent generating the parity error as the bus controller if the bus controller sent the data for the transaction.

13. The administrative agent of claim 9 further comprising:
means for storing an identifier of the agent generating the parity error in an error register of the administrative agent.

14. A computer program product for detecting an agent generating a parity error on a PCI-compatible bus, the computer program product disposed upon a signal bearing medium, the computer program product comprising computer program instructions capable of:
retrieving, by an interrupt handler from an administrative agent, an identity of an agent generating a parity error on the bus, the administrative agent having detected the parity error that occurred during a transaction on the bus connecting a plurality of agents for data communications, retrieved a value for a grant signal associated with each agent on the bus for the transaction, retrieved values for an address signal and a command signal for the transaction, and identified the agent generating the parity error in dependence upon the values for the grant signals, the address signal, and the command signal; and
administering, by the interrupt handler, the identity of the agent generating the parity error.

15. The computer program product of claim 14 wherein the signal bearing medium comprises a recordable medium.

16. The computer program product of claim 14 wherein the signal bearing medium comprises a transmission medium.

17. The computer program product of claim 14 wherein administering, by the interrupt handler, the identity of the agent generating the parity error further comprises:
logging, by the interrupt handler in an error log, the identity of the agent generating the parity error.

18. The computer program product of claim 14 wherein administering, by the interrupt handler, the identity of the agent generating the parity error further comprises:
notifying, by the interrupt handler, a user of the identity of the agent generating the parity error.
